(19) United States
(12) Patent Application Publication
(10) Pub. No.: US 2004/0162996 A1
(43) Pub. Date: Aug. 19, 2004

(54) Distributed security for industrial networks

(75) Inventors: R. Bruce Wallace, Ashton (CA); Thomas P. Chmara, Richmond (CA); Siva Subramanian, Cary, NC (US)

Correspondence Address: JOHN C. GORECKI, ESQ., 165 HARVARD ST., NEWTON, MA, 02460, US

(73) Assignee: Nortel Networks Limited, St. Laurent (CA)

(21) Appl. No.: 10/615,513

(22) Filed: Jul. 8, 2003

Related U.S. Application Data
(60) Provisional application No. 60/448,227, filed on Feb. 18, 2003.

(51) Int. Cl. H04L 9/00

(52) U.S. Cl. 713/201

(57) ABSTRACT

Distributed security for industrial networks is achieved through the implementation of Security Policy Implementation Points (SPIPs) on the network to apply security policy in a distributed fashion to prevent network users from taking action in particular areas of the network. The SPIP integrates with network services to perform authentication and authorization services on behalf of particular factory machines, groups of factory machines, and other industrial network resources. The SPIP also maintains a local access policy to enable emergency access to the factory machines as well as enable local access to attendant programmable logic controllers. The SPIP also includes audit functionality to enable the SPIP to record local accesses and network accesses to maintain a log of users and network devices that have interfaced with the SPIP. The SPIP may also support VPNs, encryption, compression, and numerous other functions to engage in communications on the network.

### BACKGROUND OF THE INVENTION

1. Field of the Invention

The present invention relates to industrial networks and, more particularly, to distributed security for industrial networks.

2. Description of the Related Art

Factories utilize vast numbers of factory machines such as robotics, process controls, sensors, and other devices to automate production of products on assembly lines. Historically, relay control boxes on the factory floor were used to control these devices. As technology developed, many relay control boxes were replaced with programmable logic controllers (PLCs) on the factory floor—small programmable devices that allow the operation of the factory machines to be altered simply by adjusting a control program configured to run on the PLC.

Initially, PLCs were maintained on the factory floor in a manner similar to how relays were maintained. Specifically, where operation of a factory machine was to be altered, a technician would go down onto the factory floor, open the PLC, enter a password, and adjust the software as necessary to effect the modifications to the factory machine's behavior. Typically access to the PLC was obtained through the use of a hand held user interface box. More recently, laptops are being used to access the PLCs.

Vendors of PLCs soon determined that it would be advantageous to network PLCs together to allow larger manufacturing processes, controlled by multiple PLCs, to coordinate with each other. Proprietary protocols were developed both to communicate between the PLC and factory machines, and between multiple PLCs. Presently PLCs are moving from proprietary network protocols to the Ethernet standards, and attempts are being made to make the PLCs accessible over the corporation's Ethernet or other local area network so that software modifications and other management functions on the PLCs may be made over the network.

Unfortunately, allowing access to the PLCs over a company's Ethernet network provides an opportunity for network users to unintentionally modify the program or otherwise effect a change on a PLC to cause the factory machine associated with the PLC to perform an incorrect series of functions on the factory floor. Additionally, a maleficent individual with authorized or unauthorized access to the corporate network may control and modify the actual operation of factory machines on the factory floor. Likewise, connecting the PLCs to the corporate network makes the PLCs vulnerable to general network malfunctions and attacks, such as broadcast storms or denial of service attacks. Unintentional and/or intentional modifications to the operation of factory machines, or a disruption in network conditions, can cost the corporation large amounts of money in damaged products and wasted resources, and may affect the physical safety of workers on the factory floor. While attempts have been made to encrypt traffic between PLCs and the central controller, encryption alone is insufficient to secure PLCs and their attendant factory machines in a networked environment.

### SUMMARY OF THE INVENTION

The present invention addresses these and other problems by allowing security policy to be implemented in a distributed fashion by enabling PLCs to take advantage of network authentication, authorization, and other network services, while enabling local policy enforcement and allowing local policy overrides where necessary. According to an embodiment of the invention, a Security Policy Implementation Point (SPIP) is configured to interface between one or more programmable logic controllers and a corporate local area network to implement controlled access to the PLC and attendant factory machines from the network. The SPIP enables the PLC to take advantage of and be integrated with enterprise-wide authentication/authorization services, supports local policy enforcement based on corporate policy services, and allows local overrides where necessary because of safety and standalone service requirements. Additionally, the SPIP includes audit-trail support to ensure local policy overrides can be reviewed at a later time. The SPIP may be formed as a stand-alone device, may be integrated into a PLC, or may be formed as a blade in an Ethernet switch configured to interface with PLCs.

According to an embodiment of the invention, the SPIP includes network ports configured to interface with the corporate network, such as an Ethernet network, and PLC ports configured to talk with one or more PLCs. Access control modules, such as an authorization module and an authentication module are provided to allow the SPIP to interface with network authorization/authentication services to ascertain the identity of the user attempting to access the PLC and whether the user is authorized to perform the requested functions. The authentication module and authorization module also include a local repository which includes sufficient content of the authentication policy and authorization information to enable local access to the PLC when network access is unavailable. An encryption module allows the establishment of a secure channel over the corporate network between the SPIP and the network services.

The SPIP also includes an user input and local access port to enable the SPIP to be accessed on the factory floor. Enabling access to the SPIP from the network floor allows workers on the floor to access the SPIP, and hence the PLC, to cause the factory machine to cease operations in an emergency. Local access to the SPIP may also be utilized to perform routine maintenance and updating functions. According to one embodiment, the SPIP is configured to allow certain aspects of network security policy to be overridden in the event of an emergency while implementing network security policy in connection with other local accesses.

A logging module enables the SPIP to create a log of PLC accesses through the SPIP, both via the network and via local access, to record the identity of the user that accessed the PLC and functions performed on the PLC. This local log will normally also be stored centrally but the local version ensures capture and follow-up recording to the central store, should the central store be unavailable or unreachable. Optionally, a display and user input such as a keyboard may also be provided to provide feedback as to actions taken on the PLC.

### BRIEF DESCRIPTION OF THE DRAWINGS

Aspects of the present invention are pointed out with particularity in the appended claims. The present invention is illustrated by way of example in the following drawings in which like references indicate similar elements. The following drawings disclose various embodiments of the present invention for purposes of illustration only and are not intended to limit the scope of the invention. For purposes of clarity, not every component may be labeled in every figure. In the figures:

FIG. 1 is a functional block diagram of a network architecture according to an embodiment of the invention;

FIG. 2 is a functional block diagram of a programmable logic controller for use with embodiments of the invention;

FIG. 3 is a functional block diagram of a Security Policy Implementation Point (SPIP) configured to interface with a PLC according to an embodiment of the invention;

FIG. 4 is a functional block diagram of a PLC incorporating a SPIP module according to an embodiment of the invention;

FIG. 5 is a functional block diagram of an network switch/router incorporating a SPIP blade according to an embodiment of the invention; and

FIG. 6 is a functional block diagram of a central controller according to an embodiment of the invention.

### DETAILED DESCRIPTION

The following detailed description sets forth numerous specific details to provide a thorough understanding of the invention. However, those skilled in the art will appreciate that the invention may be practiced without these specific details. In other instances, well-known methods, procedures, components, protocols, algorithms, and circuits have not been described in detail so as not to obscure the invention.

As described in detail below, a Security Policy Implementation Point (SPIP) is configured to implement security policy in an industrial network by providing local security services as well as interfacing with centralized network services. Thus, merely being authenticated and authorized on the network and being permitted to have access to the network does not enable a user to perform operations in a specified area protected by the SPIP unless the user is also authenticated and authorized to access that particular area or access a particular manufacturing machine. According to an embodiment of the invention, the SPIP is configured to interface between a programmable logic controller (PLC) and local area network (LAN) on an industrial network to provide a protective layer between the PLC and LAN. The SPIP, in this embodiment, enables security policy to be implemented at the PLC to prevent unintended users on the LAN from accessing the PLC and thus prevents the users from modifying the actions of a factory machine controlled by the PLC.

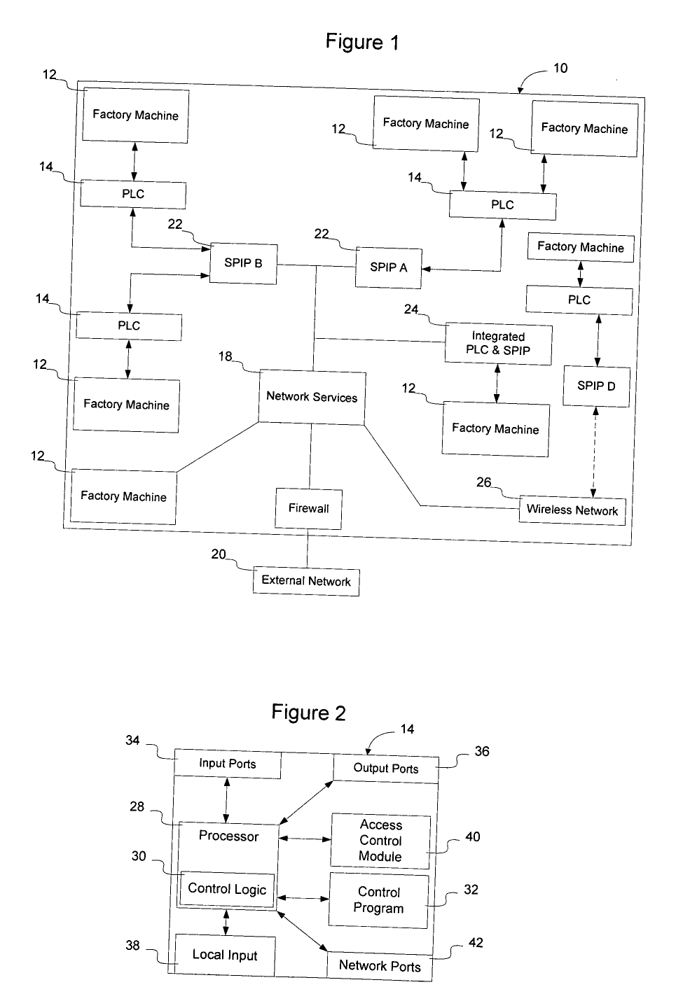

FIG. 1 illustrates one example of an industrial network 10 including multiple factory machines 12 configured to perform physical actions on the factory floor. Factory machines are used in many industries, such as in connection with manufacturing automobiles, pharmaceuticals, and electrical devices, and the invention is not limited to implementation in any particular industry.

Factory machines typically do not operate autonomously under their own intelligence, but rather are interfaced with a programmable logic controller (PLC) 14 that receives inputs from the factory machine and/or other external sensors, and controls the operation of the factory machine. An example of a PLC is discussed in greater detail below in connection with FIG. 2.

The PLCs may be connected to an industrial network 16, such as the industrial network illustrated in FIG. 1. The PLCs can be connected through the network with network services 18. Network services 18, in this embodiment, generally will be implemented via a distributed group of computers each serving to interface with one or more SPIPs and/or PLCs, to control one or more aspects of the SPIP's or PLC's operational status, or to provide one or more security services on the industrial network. Examples of network services include central logging services configured to provide a central logging facility to record actions taken on the network, authentication services, such as may be provided by a RADIUS server, and authorization services, such as may be provided by a LDAP server. Other network services may be provided as well. Network services 18 has been illustrated as a single functional block in FIG. 1 for convenience, but the invention is not limited to a single physical or logical construct on the network. Although the network services 18 in FIG. 1 are illustrated as being connected to the industrial network 10, the invention is not limited to this embodiment as the network services 18 may be located in any convenient location, including on an external network 20, and the invention is not limited to an implementation in which PLC control and other network services are handled within the industrial network. As discussed in greater detail below, according to an embodiment of the invention, security policy implementation points (SPIPs) 22 may be included on the network in particular locations to enable security policy to be implemented in connection with particular PLCs and subnetworks of PLCs.

FIG. 2 illustrates one embodiment of a PLC that may be used to control one or more factory machines. As shown in FIG. 2, a PLC 14 generally includes a processor 28 containing control logic 30 and configured to implement a control program 32 stored in memory on the PLC 14. Input ports 34 and output ports 36 enable the PLC to interface with the factory machines. The processor, when executing the control program, will control the operative state of the various outputs 36, typically “on” or “off”, in response to the detection of various external input signals received over input ports 34. A local input 38 may be provided to allow the factory machine to be stopped in the event of a malfunction or other emergency, to allow on-site modification of the PLC's control program, or to exercise manual control of the one or more devices through the PLC. An access control module 40 may be included to prevent unauthorized persons from taking action on the PLC, for example by interfacing with the PLC locally on the factory floor. According to one embodiment of the invention, the access control module 40 may be supplemented or supplanted by SPIP 22. Network ports 42 enable the PLC to be accessed over the industrial network 10.

The control program can be developed using one or more programming languages and uploaded onto the PLC. Various programming standards have been developed for use in developing application programs for PLCs. Grafcet is a graphical programming language originally developed by AFCET (Association Francais Pour La Cybernetique Economique et Technique) and has now become an international PLC programming language. IEC 1131 is a standard established by the International Electrotechnical Commission that specifies the syntax and semantics of a unified suite of programming language for programmable logic controllers. Other control software is also available, for example ActiveX Controls by Microsoft Corporation, which is an object-oriented control package that, when instantiated, embodies both specific data and the functions that manipulate it. The invention is not limited to any particular programming method or language.

To prevent unintended network users from accessing a particular PLC or group of PLCs, SPIPs 22 are interspersed in the network between the network services and PLCs to implement network security policy in connection with that PLC, group or PLCs or other network resource. One aspect of network security policy may be designed to prevent unintended access to a protected aspect of the industrial network. Unintended access may encompass many access scenarios. For example, it may be desirable to block access to persons who are not authorized to access a particular PLC. Similarly, it may be desirable to block access to persons who have not been authenticated to that particular PLC. It may also be desirable to block access to persons who are authenticated and authorized to modify PLCs on the network, but who have not verified that they are attempting to modify the control program on this particular PLC. Unintended access may also encompass an unscrupulous employee intent on damaging or creating disorder on the industrial network.

SPIPs 22 may be deployed throughout the industrial network to provide security control points where security policy may be implemented on the network. For example, a SPIP 22 may be used to provide a secure interface to a particular PLC, as in the case of SPIP A, or may be deployed to provide a secure interface to a group of PLCs, as in the case of SPIP B. Optionally, the SPIP may be incorporated into a PLC and deployed on the industrial network as an integrated unit 24.

Additional SPIPs (such as SPIP C) may be used to interface factory machines to the wireless network 26 as well. The invention is not limited to these particular placements but rather extends to all placements of SPIPs in an industrial network where it may be advantageous to implement security policy in connection with particular PLCs and other device controllers connected to the network.

The security policy to be implemented on the network may include definitions that enable the SPIP to implement security functions on the network in coordination with a central or coordinated security policy in a dynamic fashion. Examples of several definitions that may be implemented include definitions of who is to be able to obtain access to particular areas or assets deployed in a particular area, definitions of how the person or device being used by the person is to verify their identity on the network, definitions associated with emergency access, definitions associated with logging information associated with routine and emergency access, definitions associated with how communications are to take place with the SPIP, and other definitions that may be utilized to control operation of the SPIP. The invention is not limited to a particular set of security policy definitions.

The industrial network 10 may be an Ethernet network, a token ring network, or formed using other local area network (LAN) technology. Although Ethernet will be used to explain the embodiments of the invention, as Ethernet is currently a widely accepted LAN technology, the invention is not limited to implementation on an Ethernet network.

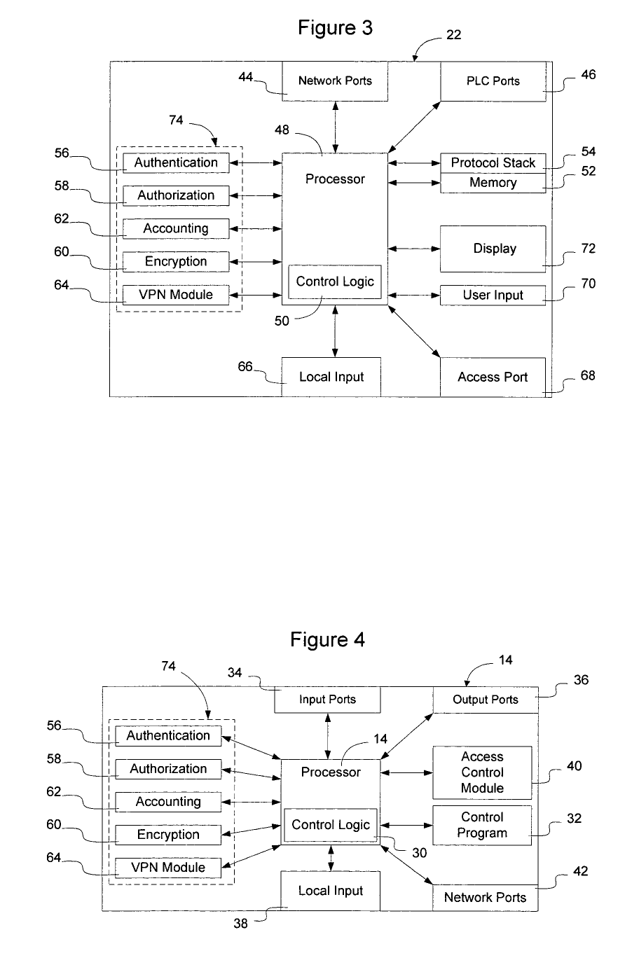

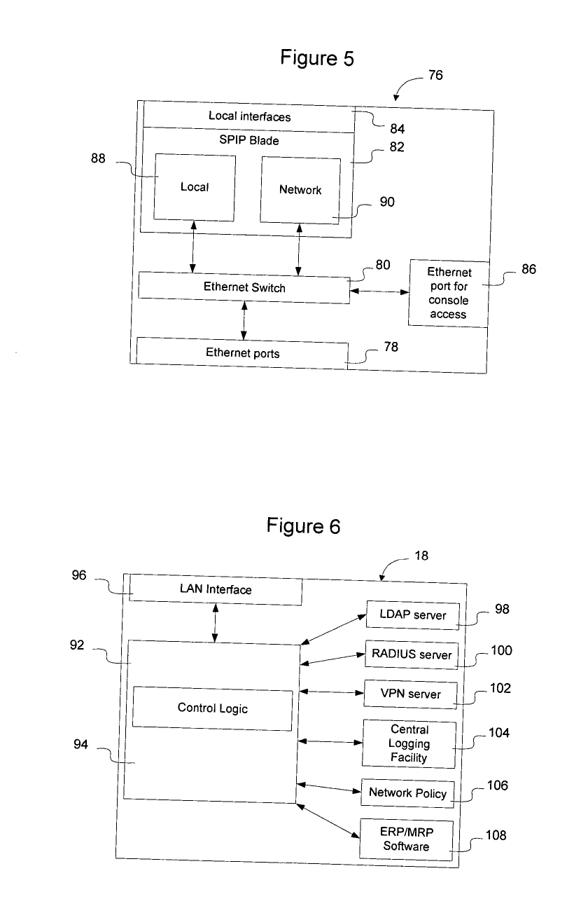

The SPIP may be implemented in a number of ways, several of which will be described below in connection with FIGS. 3-5. For example, the SPIP may be deployed on the network as a stand-alone device (FIG. 3). In this embodiment, the SPIP may be configured to communicate with the network services using one protocol, such as Ethernet, and to communicate with the PLCs using another protocol, such as a proprietary protocol understood by the PLCs. In another embodiment, the SPIP may be formed as part of the PLC to enable secure PLCs to be deployed on the factory floor (FIG. 4). In yet another embodiment, the SPIP may be implemented as a blade in an Ethernet switch or router (switch/router) on the network (FIG. 5). The invention is not limited to these particular embodiments, however, and extends to other embodiments that may be deployed on the industrial network to secure at least a portion of the industrial network.

FIG. 3 illustrates one embodiment of a SPIP according to an embodiment of the invention. As shown in FIG. 3, the SPIP 22 includes network ports 44 configured to enable the SPIP to connect to the industrial network, and PLC ports 46 configured to enable the SPIP to talk to one or more PLCs 14. The network ports 44 may be configured to communicate using well established protocols such as Ethernet or any other protocol commonly used to establish a local area network. The PLC ports 46 may be configured to interface with one or more PLCs using one or more protocols commonly used to control and interact with PLCs. Examples of such protocols include Profibus, CAN (Controller Area Network), RS-232, RS-422, RS-485, and any other protocols that may be used to control or interface with a PLC.

The SPIP contains a processor 48 having control logic 50 configured to enable it to process information received over the network, PLC, and user ports, and otherwise perform functions required to enable it to provide security functions on the network. Instructions and data may be stored in a memory 52 for use by the control logic 50 to enable it to perform the functions required of it to participate in communicating with network administrators, users, and other network devices over the networks. Interactions on the network and during protocol exchanges with other network devices on the network may be facilitated through the implementation of a protocol stack 54 containing instructions and data relevant to communications protocols commonly used on the networks and by the network devices and PLCs.

The control logic 50 may be implemented as a set of program instructions that are stored in a computer readable memory within the network device and executed on a microprocessor within the network device. However, it will be apparent to a skilled artisan that all logic described herein can be embodied using discrete components, integrated circuitry, programmable logic used in conjunction with a programmable logic device such as a Field Programmable Gate Array (FPGA) or microprocessor, or any other device including any combination thereof. Programmable logic can be fixed temporarily or permanently in a tangible medium such as a read-only memory chip, a computer memory, a disk, or other storage medium. Programmable logic can also be fixed in a computer data signal embodied in a carrier wave, allowing the programmable logic to be transmitted over an interface such as a computer bus or communication network. All such embodiments are intended to fall within the scope of the present invention.

The SPIP may contain various security modules 74 to enable it to apply security policy on the network. These security modules 74 may be implemented on the SPIP to enable the SPIP to perform specific security related functions and provide security services on the network 10, and to integrate where possible with the corporate security services such as those provided by network services 18. Operation of the security modules 74 may be defined in the security definitions discussed above. In the embodiment illustrated in FIG. 3, the SPIP includes an authentication module 56, an authorization module 58, an encryption module 60, an accounting module 62, and a VPN module 64. The invention is not limited to a SPIP employing this particular set of modules or only these particular selected modules, but rather extends to other embodiments with additional or alternative functional modules.

In the embodiment illustrated in FIG. 3, the authentication and authorization modules enable the SPIP to ascertain the identity of the user attempting to access the PLC through the SPIP, and ascertain whether the user is authorized to perform the requested functions on the PLC or other protected network asset. The authentication and authorization modules may be configured to interface with a centralized authentication and authorization server, such as an LDAP/RADIUS server to obtain authentication and authorization services on behalf of the SPIP from a centralized resource. Additionally, the authorization and authentication modules may be configured to maintain a full or partial local copy of authorized or unauthorized users and authentication policy to allow local access even when the central policy (LDAP/RADIUS) server is not available.

The encryption module 60 allows the SPIP to establish a secure channel over the network between the SPIP and the central control.

The Virtual Private Network (VPN) module 64 may be provided to enable secure communications channels to be set up between the SPIP and the central control or other network devices configured to interface with the SPIP. Utilization of a VPN module may be particularly advantageous where the central control or other network device is not located on the corporation's intranet, or where many third parties (e.g. suppliers) have been provided with access to the industrial network and the industrial network cannot therefore be considered a trusted environment. Establishment of a secure transmission channel such as a VPN tunnel in this environment may advantageously prevent unauthorized individuals from viewing and/or modifying the communications between the SPIP and the central control or other network device, as well as providing other common benefits attendant to VPNs such as application of Quality of Service (QoS).

The accounting module 62 enables a record to be created and maintained of accesses on the network device, and the types of functions that were performed, so that it is possible to track which user(s) or network devices have been accessing the SPIP and the functions performed by the various users. The ability to track users' actions on the PLCs serves both as a deterrent mechanism (people are less likely to act badly when they know they will be caught) and a tracking mechanism which allows persons and machines accessing the device to be identified. The accounting module may also maintain a local record of accesses, attempts, and other information, such as during periods when a central logging service is not available or as a backup to the central logging service. The accounting module may also be configured to synchronize the local log with the central logging service, such as after restoration of network connectivity.

The SPIP 22 may also include features to allow it to be accessed from the factory floor. For example, the SPIP may be associated with a PLC that is controlling a factory machine and causing the factory machine to perform physical manipulations on objects on the factory floor. In this scenario, there may be a possibility that the factory machine could physically injure a worker on the floor. The security policy implemented on the factory floor thus needs to allow workers to cause the factory machine to stop or alter its routine functions in the event of an emergency regardless of the corporate authentication/authorization policy associated with PLC access. Additionally, it may be advantageous to perform maintenance and other modifications to the PLC locally rather than over the network. Accordingly, to implement these policy considerations, the SPIP illustrated in FIG. 3 includes a local input 66 to allow workers on the factory floor to access the SPIP to cause the factory machine to cease or alter operations. Access through the local input may depend on the nature of the access. Specifically, in the event of an emergency access, the SPIP may override authentication/authorization policies to allow access to the factory machine, while maintaining an audit trail so that the nature of the emergency, the respondent, and the actions taken may be recorded in the local log and/or central log service. By contrast, where the local input is to be used to update the PLC control program in a non-emergency situation, however, the SPIP may implement the authentication/authorization policies as well as maintain an audit trail. Thus, the security policy applied to a local access attempt may include considerations such as the nature of the local access attempt. The local input 66 may include one or more manual data input devices 70, such as a keyboard, mouse, stylus, touch pad, touch screen, emergency off button, or other user input to allow the user to access the PLC through the SPIP.

An access port 68 may be provided to enable the PLC to be accessed locally, such as through connection to a laptop computer, to allow an operator to modify the code in the PLC without accessing the PLC through network services 18. The access port may be an infra-red port, Ethernet port, serial port, or other communications port to enable the PLC to connect with another electronic device, such as a laptop computer, PDA, or other hand-held computing unit. The SPIP may also include a display 72 to enable visual interaction between the user and the SPIP, although the invention is not limited to a SPIP including a visual display.

FIG. 4 illustrates a PLC having included therein security modules 74 to enable the PLC to implement security policy on the industrial network 10. The use of an integrated SPIP and PLC is illustrated in FIG. 1 (integrated PLC and SPIP 24). As shown in FIG. 4, the integrated PLC/SPIP (integrated device) includes a set of security modules 74 to enable the integrated device to implement security policy and perform security functions in the same manner as discussed above in connection with FIG. 3. The integrated device also includes input ports 34, output ports 36, network ports 42 and an local input 38 as discussed above in connection with FIG. 2. The integrated device also includes a control program 32 to enable the integrated device to control one or more factory machines connected thereto. Optionally, a native access module 40 may be included, as discussed above in connection with FIG. 2 to enable the integrated device to have a local access control mechanism. Other modules may also be provided, such as a display, user input, memory, and protocol stack, to enable the PLC to perform functions associated with both a PLC and a SPIP.

The input ports may receive input signals generated by numerous types of environmental sensors, such thermocouples, pressure gauges, flow meters, and other commonly utilized measuring devices. The output ports may also include servo ports, such as analog or digital direct control interfaces to control devices such as valves, solenoids, electrical switches, relays, and other commonly controlled electro-mechanical mechanisms. The invention is not limited to use of the integrated device or PLC with any particular type of electrical or electro-mechanical device.

FIG. 5 illustrates an embodiment of the invention in which an embedded SPIP is included as a blade in an Ethernet switch/router 76 to enable the switch/router to implement security policy to secure devices attached to that blade. As shown in FIG. 5, the Ethernet switch/router according to this embodiment includes one or more Ethernet ports 78 connected to an Ethernet switch/router backplane 80. A SPIP blade 82 is included to interface the Ethernet switch/router to one or more PLCs. Local interfaces 84, in this embodiment, enable the SPIP blade to connect with PLCs 14. Optionally, the Ethernet switch/router 76 may also include an Ethernet port for local console access 86 to enable local input in an emergency and in connection with the performance of local maintenance, as described above.

The SPIP of FIG. 3, the integrated SPIP of FIG. 4, and the SPIP blade of FIG. 5 each include two paths: a local path 88 and a network path 90. The local path enables implementation of an emergency local access policy that ensures that access is available to the PLCs associated with the SPIP even when there is a failure on the factory LAN that otherwise would prevent access to the PLC from the central control. The emergency local access policy also allows for non-blocking access to the PLC from the factory floor, i.e. by providing unlimited attempts to access the device via input of a password) so that the device may always be shut off or reconfigured in the event of an emergency. The local path also contains a fail-safe recovery state to enable the SPIP to recover upon failure to minimize the down-time associated with failures at the SPIP.

The local path also provides a local audit trail for access and events to enable local accesses to be tracked from and reported to the network services. Recording field modifications from the factory floor enables the network services to understand which technician has modified the PLC code and what modifications have been made, and enables the network services, network administrator, or factory foreman to take appropriate action in the event of an improper or incorrect modification to the PLC code.

The network path enables access the SPIP to access the factory network, and receive services over the factory network. The network path enables the SPIP to obtain secure network paths on the factory LAN, obtain guaranteed levels of service on the LAN (obtain QoS) and otherwise obtain bandwidth services on the factory network. The network path also enables the SPIP to integrate with network services to obtain authentication and authorization services on the network, engage the central logging facility, and communicate using encrypted transmissions on the network. The network path may also support data compression and include other functionality, such as an extensible markup language (XML) acceleration module to validate XML messages to prevent XML layer Distributed Denial Of Service (DDOS) attacks on the SPIP. The XML acceleration module may also provide XML signature validation and authentication, and perform XML encryption. The invention is not limited to any particular embodiment but rather extends to other embodiments employing other modules configured to provide additional functionality to the SPIP.

FIG. 6 illustrates a network device configured to implement at least a portion of network services 18, and configured to interface with the SPIPs according to an embodiment of the invention. As shown in FIG. 6, the network device contains a processor 92 containing control logic 94 configured to interface with local area network 16 over LAN interface 96, and otherwise perform functions associated with the provision of network services. The network device may contain modules or interfaces to modules configured to perform centralized security services, such as an Lightweight Directory Access Protocol (LDAP) server 98, a Remote Access Dial In User Service (RADIUS) server 100, a VPN server 102, and a central logging facility 104. A network policy server 106 may also be implemented to assign bandwidth on the network and to otherwise enforce network policy on the network. An Enterprise Resource Planning (ERP)/Manufacturing Resource Planning (MRP) software package 108 may also be instantiated to enable all aspects of the business and manufacturing to be controlled by network services 18. Typical functions performed associated with an ERP/MRP software package include inventory control, order management, accounting, invoicing and other aspects associated with running an enterprise.

The industrial network may be associated with a manufacturing plant, as described above, or may be associated with other industries with a need to secure particular assets from intrusion while enabling those assets to communicate over a corporate intranet. Accordingly, the invention is not limited to deployment of the security policy implementation points in an industrial network configured to interconnect factory machines intended to be used in the development of product on an assembly line.

It should be understood that various changes and modifications of the embodiments shown in the drawings and described in the specification may be made within the spirit and scope of the present invention. Accordingly, it is intended that all matter contained in the above description and shown in the accompanying drawings be interpreted in an illustrative and not in a limiting sense. The invention is limited only as defined in the following claims and the equivalents thereto.

What is claimed is:

Claim:

1. A industrial network, comprising:
a local area network; and
a security policy implementation point (SPIP) configured to apply policy in the control of network access to at least one factory machine.

2. The industrial network of claim 1, further comprising a programmable logic controller connected to the at least one factory machine, and wherein the SPIP is integrated with the programmable logic controller.

3. The industrial network of claim 1, further comprising a programmable logic controller connected to the at least one factory machine, and wherein the SPIP interfaces between the local area network and the programmable logic controller.

4. The industrial network of claim 3, wherein the local area network is an Ethernet network, wherein the SPIP is configured to communicate with network devices on the local area network over the Ethernet network, and wherein the SPIP is configured to communicate with the programmable logic controller using a protocol selected from at least one of Profibus, Controller Area Network, RS-232, RS-422, and RS-485.

5. The industrial network of claim 1, wherein the local area network includes at least one Ethernet switch/router, and wherein the SPIP is included as a blade in the Ethernet switch/router.

6. The industrial network of claim 5, wherein the SPIP is configured to implement security policy to control network access to at least one PLC connected to the Ethernet switch/router through the SPIP.

7. The industrial network of claim 6, wherein the subnet includes at least one programmable logic controller is configured to control the operation of at least one of said factory machines.

8. The industrial network of claim 1, wherein the SPIP comprises an authentication module and an authorization module to control network access to said factory machine.

9. The industrial network of claims, wherein the industrial network is an untrusted network configured to interconnect network services with a plurality of SPIPs associated with factory machines, and wherein the network services are configured to enable operation of the factory machines to be altered through the industrial network.

10. The industrial network of claim 1, wherein the SPIP includes a local policy configured to enable the SPIP to enforce network policy in connection with local accesses.

11. The industrial network of claim 10, wherein the local policy comprises:
a local access policy configured to require authentication and authorization of at least one of an user and an accessing electronic device for non-emergency attempts to access the SPIP, and
an alternate access policy configured to allow access to the SPIP and maintain an audit log attendant to a local attempt to access the SPIP.

12. The industrial network of claim 1, wherein the SPIP comprises a network policy configured to enable the SPIP to enforce network policy by interfacing with network services.

13. The industrial network of claim 12, wherein the SPIP comprises a local authentication policy and information associated with authorized users and indicative of authorization policy information associated with said at least one factory machine.

14. A Security Policy Implementation Point (SPIP) for use in an industrial network, comprising:
a local path configured to implement a local access policy; and
a network path configured to secure network paths on the industrial network.

15. The SPIP of claim 15, further comprising programmable logic controller circuitry configured to function to control at least one factory machine.

16. The SPIP of claim 15, wherein the local access policy includes enabling access to an associated factory machine to enable operation of the factory machine to be altered without verification of authorization and authentication of an user seeking to alter the operation.

17. The SPIP of claim 16, wherein the local path further comprises an accounting module configured to record accesses to at least one of the SPIP, an associated programmable logic controller, and an associated factory machine.

18. The SPIP of claim 15, wherein the local path comprises an authentication module configured to authenticate the identity of an individual seeking to access a device through the SPIP, and an authorization module configured to assess an authorization associated with the individual to ascertain whether the individual is authorized to access the device.

19. The SPIP of claim 18, wherein the authorization module is an interface to a Lightweight Directory Access Protocol (LDAP) server, and wherein the authentication module is an interface to a Remote Access Dial In User Service (RADIUS) server.

20. The SPIP of claim 18, wherein the authentication and authorization modules maintain a local copy of authorized users and authentication policy to allow local access to the SPIP.

21. The SPIP of claim 15, wherein the local path comprises a virtual private network module configured to participate in a virtual private network tunnel established on the industrial network.

22. The SPIP of claim 15, further comprising network ports configured to interface with the industrial network, and output ports configured to interface with a programmable logic controller.

23. The SPIP of claim 22, wherein the network ports are configured to communicate on the industrial network utilizing an Ethernet protocol; and wherein the output ports are configured to communicate with the programmable logic controller using a protocol understandable by the programmable logic controller.

24. The SPIP of claim 15, further comprising network ports configured to interface with the industrial network, control logic configured to implement a control program associated with a programmable logic controller, and interface ports configured to interface with a factory machine.

25. The SPIP of claim 24, wherein the interface ports comprise at least one input port configured to receive input from an environmental sensor, and at least one output port configured to control at least one electro-mechanical device.
